(19) United States
(12) Patent Application Publication
(10) Pub. No.: US 2025/0019239 A1
(43) Pub. Date: Jan. 16, 2025

(54) INTEGRATED PROCESS FOR CO-PRODUCING PHOSPHORUS PENTAFLUORIDE (PF5) AND FLUOROSULFONIC ACID (HSO3F)

(71) Applicant: Honeywell International Inc., Charlotte, NC (US)

(72) Inventors: Haiyou Wang, Amherst, NY (US); Bernard Pointner, Buffalo, NY (US); Xinrui Yu, Furlong, PA (US); Akbar Mahdavi-Shakib, Buffalo, NY (US)

(21) Appl. No.: 18/744,606

(22) Filed: Jun. 15, 2024

Related U.S. Application Data
(60) Provisional application No. 63/525,047, filed on Jul. 5, 2023.

(51) Int. Cl. C01B 25/10; C01B 17/46

(52) U.S. Cl. CPC C01B 25/10; C01B 17/463; C01P 2002/82; C01P 2002/86; C01P 2006/80

(57) ABSTRACT

An integrated process for co-producing phosphorus pentafluoride (PF₅) and fluorosulfonic acid (HSO₃F) in high yield and purity via a single reaction step is provided. The method includes reacting a first reagent comprising an aqueous solution of hexafluorophosphoric acid (HPF₆) and hydrofluoric acid (HF) with a second reagent comprising fuming sulfuric acid (H₂SO₄·SO₃) and recovering a product mixture comprising phosphorus pentafluoride (PF₅) and fluorosulfonic acid (HSO₃F).

### CROSS-REFERENCE TO RELATED APPLICATION

This application claims the benefit under 35 U.S.C. § 119 (e) of Provisional Application No. 63/525,047, filed Jul. 5, 2023, which is herein incorporated by reference in its entirety.

### FIELD

The present disclosure relates to the raw materials phosphorus pentafluoride (PF₅) and fluorosulfonic acid (HSO₃F) and to an integrated process for co-producing phosphorus pentafluoride (PF₅) and fluorosulfonic acid (HSO₃F).

### BACKGROUND

Among commercially produced batteries, lithium ion batteries have one of the best energy-to-weight ratios, no memory effect, and a slow loss of charge when not in use. In addition to powering a wide variety of consumer electronics, lithium ion batteries are growing in popularity for defense, automotive, and aerospace applications due to their high energy density.

Lithium hexafluorophosphate (LiPF₆) and lithium bis (fluorosulfonyl) imide (LiFSI) are two electrolytes often used in lithium ion batteries. Phosphorus pentafluoride (PF₅) can be used to produce lithium hexafluorophosphate (LiPF₆), while fluorosulfonic acid (HSO₃F) can be used to make hydrogen bis (fluorosulfonyl) imide (HFSI), an intermediate that can be used to produce lithium bis (fluorosulfonyl) imide (LiFSI). There continues to be a need for lithium salts for use in electrolyte solutions. However, many existing methods produce undesirable side products such as hydrofluoric acid (HF) or phosphoryl fluoride (POF₃) which require energy intensive and costly purifications to remove.

Applicants appreciate the need for producing the raw materials needed for manufacture of lithium ion batteries in high yield and purity, including phosphorus pentafluoride (PF₅) and fluorosulfonic acid (HSO₃F).

### SUMMARY

The present disclosure provides an integrated process for the co-production of phosphorus pentafluoride (PF₅) and fluorosulfonic acid (HSO₃F) from oleum (H₂SO₄·SO₃) and an aqueous solution containing hydrofluoric acid (HF) and hexafluorophosphoric acid (HPF₆).

In one form thereof, the present disclosure provides an integrated process for co-producing phosphorus pentafluoride (PF₅) and fluorosulfonic acid (HSO₃F) comprising: (1) reacting anhydrous hydrofluoric acid (AHF) with polyphosphoric acid (H₃PO₄) in a first reactor to produce a first product mixture comprising hexafluorophosphoric acid (HPF₆); and (2) reacting the first product mixture with oleum (H₂SO₄·SO₃) in a second reactor to produce a second product mixture comprising phosphorus pentafluoride (PF₅) and fluorosulfonic acid (HSO₃F).

In another form thereof, the present disclosure provides a process for co-producing phosphorus pentafluoride (PF₅) and fluorosulfonic acid (HSO₃F) comprising: (1) reacting hexafluorophosphoric acid (HPF₆) with oleum (H₂SO₄·SO₃) in a reactor; (2) collecting an overhead stream comprising phosphorus pentafluoride (PF₅) from the reactor; and (3) collecting a bottoms stream comprising fluorosulfonic acid (HSO₃F) from the reactor.

### BRIEF DESCRIPTION OF THE DRAWINGS

The above mentioned and other features of the disclosure, and the manner of attaining them, will become more apparent and the disclosure itself will be better understood by reference to the following description of embodiments of the disclosure taken in conjunction with the accompanying drawings.

FIG. 1 is a schematic diagram of an integrated process for producing phosphorus pentafluoride (PF₅) and fluorosulfonic acid (HSO₃F) which corresponds to Example 5.

FIG. 2 is a schematic diagram of an integrated process for producing phosphorus pentafluoride (PF₅) and fluorosulfonic acid (HSO₃F) which corresponds to Example 6.

FIG. 3 is a ¹⁹F NMR spectrum of autoclave contents after the completion of the reaction from Example 2a.

FIG. 4 is a ³¹P NMR spectrum of autoclave contents after the completion of the reaction from Example 2a.

FIG. 5 is a FTIR spectrum of recovered product from the product collection cylinder from Example 2a.

The exemplification set out herein illustrates an embodiment of the disclosure, and such exemplification is not to be construed as limiting the scope of the disclosure in any manner.

### DETAILED DESCRIPTION

### I. Definitions

As used herein, the term “about”, when used in connection with numerical values such as recited weight percentages of the components of the present compositions, pressures, and temperatures includes a deviation of +0.3% from the recited weight percentage.

As used herein, the singular forms “a”, “an” and “the” include plural unless the context clearly dictates otherwise. Moreover, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the disclosure be limited to the specific values recited when defining a range.

As used herein, the term “substantially free” means that the composition as a whole contains no more than about 1% by weight of the species in question. For example, if a product composition is substantially free of hydrofluoric acid (HF), it contains no more than about 1 wt. % of hydrofluoric acid (HF).

As used herein, the phrase “within any range encompassing any two of these values as endpoints” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

### II. Integrated Process for Co-Producing Phosphorus Pentafluoride (PF₅) and Fluorosulfonic Acid (HSO₃F)

The present disclosure provides an integrated process for co-producing phosphorus pentafluoride (PF₅) and fluorosulfonic acid (HSO₃F). Advantageously, the method provides highly pure phosphorus pentafluoride (PF₅) which is substantially free of hydrofluoric acid (HF), thereby eliminating the need for an hydrofluoric acid (HF) recycling, separation, or treatment steps.

In one embodiment, the method comprises: (i) reacting anhydrous hydrofluoric acid (HF) with polyphosphoric acid (H₃PO₄) in a first reactor to produce a first product mixture comprising hexafluorophosphoric acid (HPF₆); and (ii) reacting the first product mixture and oleum (H₂SO₄·SO₃) in a second reactor to produce a second product mixture comprising phosphorus pentafluoride (PF₅) and fluorosulfonic acid (HSO₃F).

Schematic equations for these reactions are represented in Scheme 1 below:

Scheme 1

(6+n)HF+H₃PO₄→HPF₆+4H₂O+nHF (i)

[HPF₆+4H₂O+nHF]+(5+n)SO₃→PF₅+4H₂SO₄+(1+n)HSO₃F (ii)

In Scheme 1, “n” refers to the number of moles of excess HF used in the first step to produce hexafluorophosphoric acid (HPF₆). The value for n may be as low as 0, as high as 100, or any integer within this range. When a larger excess of HF is present, more HOS₃F can be made.

In some embodiments, the method may involve co-production of phosphorus pentafluoride (PF₅) and HSO₃F fluorosulfonic acid (HSO₃F) in a single reaction in the same reactor. The method may be an integrated or continuous process.

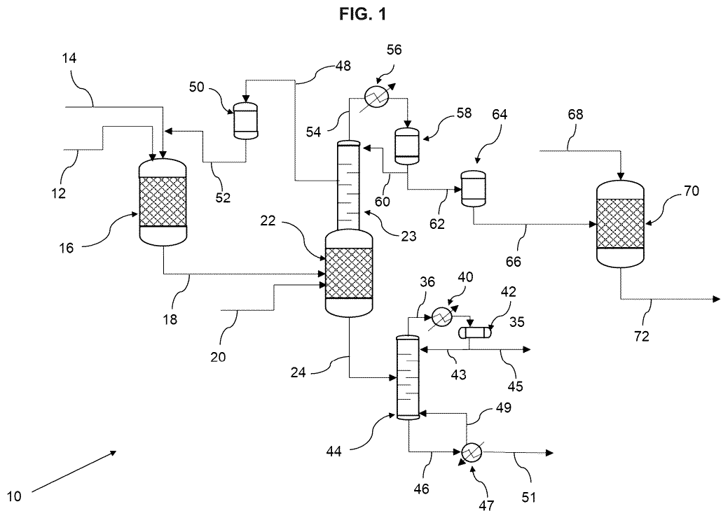

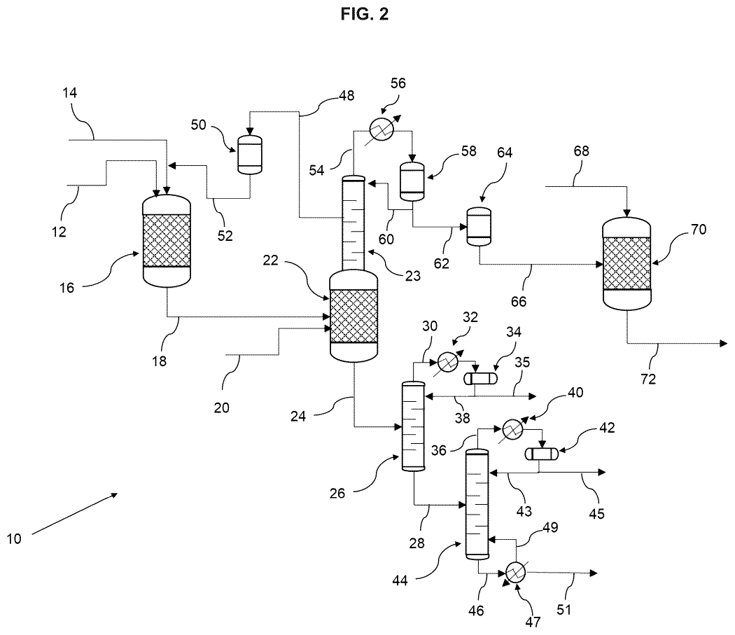

An exemplary embodiment of this method is provided in FIGS. 1 and 2. Referring to these figures, a method for co-production of phosphorus pentafluoride (PF₅) and HSO₃F fluorosulfonic acid (HSO₃F) is shown by the process flow diagrams 10.

In the first step, hexafluorophosphoric acid (HPF₆) is produced in reactor 16. Suitable reactors include a cylindrical reactor made from a material which is resistant to temperature and/or corrosion such as nickel and its alloys, including Hastelloy (for example, Hastelloy C-276), Inconel (for example, Inconel 600), Incoloy, and Monel, and the vessels may be lined with fluoropolymers. The reactor may be first cleaned and flushed with an inert gas such as nitrogen or argon before being evacuated.

After reactor 16 is evacuated, anhydrous hydrogen fluoride (AHF) is charged to it in stream 12 and polyphosphoric acid (H₃PO₄) is charged to it in stream 14. The anhydrous hydrogen fluoride is substantially free of water. That is, any water in the anhydrous hydrogen fluoride is in an amount by weight less than about 500 parts per million, about 300 ppm, about 200 ppm, about 100 ppm, about 50 ppm, about 30 ppm, about 20 ppm, about 10 ppm, about 5 ppm, about 3 ppm, about 2 ppm, or about 1 ppm, or less than any value defined between any two of the foregoing values. Preferably, the anhydrous hydrogen fluoride comprises water by weight in an amount less than about 100 ppm. More preferably, the anhydrous hydrogen fluoride comprises water by weight in an amount less than about 50 ppm. Most preferably, the anhydrous hydrogen fluoride comprises water by weight in an amount less than about 10 ppm.

The polyphosphoric acid (H₃PO₄) fed into reactor 16 may have the following formula:

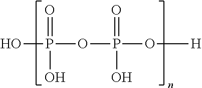

In the above formula, n may be any integer from 2 to 14.

The polyphosphoric acid (H₃PO₄) may be heated before being charged to the reactor. For example, the polyphosphoric acid (H₃PO₄) may be at a temperature as low as about 35° C., about 45° C., about 50° C., or as high as about 55° C., about 60° C., about 65° C., or within any range encompassed by any two of these values as endpoints. In some embodiments, the polyphosphoric acid (H₃PO₄) may be heated to a temperature of about 40° C. to about 60° C. The polyphosphoric acid (H₃PO₄) may be added to the reactor slowly over a period of several hours while the reactor contents are being agitated. For example, the polyphosphoric acid (H₃PO₄) may be added over a period of 5 to 10 hours. In some preferred embodiments, the reaction may utilize a stoichiometric excess of anhydrous HF relative to the amount of polyphosphoric acid (H₃PO₄).

After or during reactor 16 is charged with neat anhydrous HF and neat polyphosphoric acid, phosphoryl fluoride (POF₃) and phosphorus pentafluoride (PF₅) generated in reactor 22 and collected in collection tank 50 can be added to reactor 16 as a mixture in stream 52.

As the reagents are added to reactor 16, an elevated temperature up to 50° C. or higher may be observed. The reactor is continuously stirred until it cools down to below 30° C. at which point the reaction is complete.

At this point, a sample of the reaction contents may be taken to measure the concentration of hexafluorophosphoric acid (HPF₆). The concentration of hexafluorophosphoric acid (HPF₆) may be determined by doing a Karl-Fischer titration of the reaction contents which will give the water content and the excess amount of HF based on stoichiometric ratio. The weight percentage of hexafluorophosphoric acid (HPF₆) is then calculated by subtracting the weight percentages of water and excess HF from 100%. The concentration of hexafluorophosphoric acid (HPF₆) may be as low as about 55 wt. %, about 56 wt. %, about 57 wt. %, about 58 wt. %, about 59 wt. %, about 60 wt. %, about 61 wt. %, about 62 wt. %, about 63 wt. %, about 64 wt. %, about 65 wt. %, about 66 wt. %, about 67 wt. %, about 68 wt. %, or as high as about 69 wt. %, about 70 wt. %, about 71 wt. %, about 72 wt. %, about 73 wt. %, about 74 wt. %, about 75 wt. %, or within any range encompassed by any two of the foregoing values as endpoints. For example, the concentration of hexafluorophosphoric acid (HPF₆) may be between about 50% and about 60%.

After completion of the reaction in reactor 16, stream 18 which comprises hexafluorophosphoric acid (HPF₆) is removed and flows towards reactor 22.

In the second step, phosphorus pentafluoride (PF₅) and fluorosulfonic acid (HSO₃F) are produced in reactor 22 which is outfitted with an overhead distillation column 23. After reactor 22 is evacuated, hexafluorophosphoric acid (HPF₆) from stream 18 and oleum (H₂SO₄·SO₃) in stream 20 are separately added into the reactor. In some embodiments, the reaction step between hexafluorophosphoric acid (HPF₆) and hydrofluoric acid (HF) with oleum (H₂SO₄·SO₃) involves using a stoichiometric excess of oleum relative to the amount of hexafluorophosphoric acid (HPF₆). This excess helps mitigate the production of hydrofluoric acid (HF) in the reaction since any hydrofluoric acid (HF) is immediately converted to fluorosulfonic acid (HSO₃F). In addition, using an excess of oleum minimizes water content and thus minimizes the PF₅ hydrolysis reaction.

Under the foregoing conditions, the amount of HF in streams 24, 48, or 54 may be less than 5 wt. %, less than 3 wt. %, less than 1 wt. %, less than 0.5 wt. %, less than 0.1 wt. %, or less than 0.01 wt. %, based on the total weight of the contents of each stream.

As reactor 22 is charged with reactants, cooling may be applied to cool the reactor temperature to as low as about 0° C., about 1° C., about 2° C., about 3° C., about 4° C., about 5° C., about 6° C., about 7° C., about 8° C., about 9° C., about 10° C., or within any range encompassed by any two of the foregoing values as endpoints. For example, the reactor may be maintained at about 2° C. to about 5° C. As the reaction proceeds, the reaction temperature is controlled to be below about 20° C. before about 60% of the oleum is added. The cooling and the oleum rate can then be adjusted to maintain the overhead pressure of phosphorus pentafluoride (PF₅) to be about of as low as about 1 psig, about 2 psig, about 3 psig, about 4 psig, about 5 psig, about 6 psig, about 7 psig, or as high as about 8 psig, about 9 psig, about 10 psig, about 11 psig, about 12 psig, about 13 psig, about 14 psig, about 15 psig, or within any range encompassed by any two of the foregoing values as endpoints. For example, the phosphorus pentafluoride (PF₅) pressure may be maintained at a pressure of about 3 psig to about 10 psig.

The mixture of products obtained from reactor 22 may include phosphorus pentafluoride (PF₅), phosphoryl fluoride (POF₃), difluorophosphoric acid (HPO₂F₂), fluorosulfonic acid (HSO₃F), sulfuric acid (H₂SO₄), and H₂PO₃F. Some products such as phosphorus pentafluoride (PF₅) and phosphoryl fluoride (POF₃) may be recovered in the gas phase whereas others such as fluorosulfonic acid (HSO₃F) may be recovered in the liquid phase. In some embodiments, the product mixture may comprise phosphorus pentafluoride (PF₅) and fluorosulfonic acid (HSO₃F) are in a ratio of from about 60 wt. %:40 wt. % to about 80 wt. %:20 wt. %. In other embodiments, the product mixture may be substantially free of hydrofluoric acid (HF) or phosphoryl fluoride (POF₃).

The gaseous products from reactor 22 including phosphorus pentafluoride (PF₅) and phosphoryl fluoride (POF₃) are separated in the distillation column 23 above reactor 22. The overhead stream 54 contains phosphorus pentafluoride (PF₅) and is conveyed through cooler 56 into collection tank 58. Side stream 48, which contains a mixture of phosphoryl fluoride (POF₃) and phosphorus pentafluoride (PF₅), is fed back into collection tank 50. Stream 52 conveys the contents of collection tank 50 into stream 14 which feeds back into reactor 16. As the pressure in reactor 22 starts to drop, the reactor may be heated up to about 110° C. to drive off the remaining gaseous products. The recovered PF₅ in collection tank 58 may be greater than 90% pure, greater than about 95% pure, greater than about 99% pure, or greater than about 99.9% pure as measured by FTIR spectroscopy.

In the third step, the contents of collection tank 58 are fed out through stream 62 into holding tank 64. Stream 60 branches off from stream 62 and conveys PF₅ from collection tank 58 back into distillation column 23 for additional purification. Stream 66 conveys PF₅ from holding tank 64 into reactor 70. Simultaneously, stream 68 which contains lithium fluoride (LiF) and solvent is fed into reactor 70. The reaction in reactor 70 produces lithium hexafluorophosphate (LiPF₆) which is removed in stream 72.

Referring to FIG. 1, in the fourth step, the bottoms stream 24 containing fluorosulfonic acid (HSO₃F) and sulfuric acid (H₂SO₄) is conveyed to distillation column 44. Distillation column 44 may have 10 stages and a reflux ratio of about 3.0. In some embodiments, the column bottom may be preloaded with sulfuric acid (H₂SO₄). Fluorosulfonic acid (HSO₃F) is recovered in the overhead stream 36 which is pumped through pump 40 into collection tank 42. From collection tank 42, stream 43 is removed which conveys fluorosulfonic acid (HSO₃F) back into distillation column 44 for further purification. Stream 45, containing purified fluorosulfonic acid (HSO₃F) is collected and removed. The recovered fluorosulfonic acid (HSO₃F) may be greater than about 90% pure, greater than about 95% pure, greater than about 99% pure, or greater than about 99.9% pure as measured by NMR spectroscopy.

Bottoms stream 46, containing sulfuric acid (H₂SO₄) and other heavy impurities is removed from distillation apparatus 44 and conveyed through pump 47. Pump 47 provides stream 49 which is returned into distillation column 44 for further purification and stream 51 containing purified sulfuric acid (H₂SO₄) which is removed.

FIG. 2 provides a schematic of the integrated process with an optional further purification to recover useful by-products such as difluorophosphoric acid (HPO₂F₂) and fluorosulfonic acid (HSO₃F). After the temperature or reactor 22 cools to below about 50° C., bottoms stream 24 may be conveyed to distillation column 26 to separate difluorophosphoric acid (HPO₂F₂). Distillation column 26 may have 8 stages and a reflux ratio of 1.5. The overhead stream 30, containing purified difluorophosphoric acid (HPO₂F₂) is conveyed through cooler 32 and into collection tank 34. From collection tank 34, stream 38 is removed which flows difluorophosphoric acid (HPO₂F₂) back into distillation column 26 for further purification. Stream 35 containing purified difluorophosphoric acid (HPO₂F₂) is collected and removed. The collected difluorophosphoric acid (HPO₂F₂) may be greater than about 90% pure, greater than about 95% pure, greater than about 99% pure, or greater than about 99.9% pure as measured by NMR spectroscopy.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances that fall within the scope of the appended claims.

### EXAMPLES

### Example 1a-Hexafluorophosphoric Acid (HPF₆) Formation in a Single Reactor System

In this example, ca. 116.5 g of AHF (Advance Research Chemicals, Inc.) was transferred to a pre-weighed PFA bottle (Savillex, 375 mL Column Component Vessel, Flat Interior, 1½″ MNPT) which was fitted with a PFA closure (Savillex, 58 mm Transfer Closure, ¼″ OD Tube Port, 1½″ FNPT) and a PFA plug valve (Swagelok, ¼ in. Swagelok Tube Fitting). The PFA vessel containing the AHF was then inverted and connected via all fluoroplastic and stainless steel ¼″ connections to a Teflon-lined 600 ml stainless-steel autoclave (Parr Instrument Co., Series 4560). The autoclave was then evacuated before the AHF was introduced into the autoclave reactor. Once the AHF transfer was complete the autoclave reactor was isolated and cooled to ca. 2-5° C. in an ice water bath while the PFA transfer bottle was re-weighed. Inside an N₂-purged glove bag, ca. 68.6 g of polyphosphoric acid (Sigma-Aldrich, H₃PO₄ 115%), previously warmed in a hot water bath, was poured into a 250-500 ml three-neck round bottom glass flask through a Teflon funnel. The flask was then sealed and removed to the fume hood where it was placed on a heating mantle which was placed on a scale and then connected to a peristaltic pump via all fluoroplastic fittings and tubing. The peristaltic pump was then connected to the autoclave reactor through all fluoroplastic fittings and tubing. The polyphosphoric acid (H₃PO₄) was then heated to ca. 80° C. under a continuous N₂-flow before being slowly pumped into the autoclave reactor at a rate of 1.5-2 g/min. The AHF and polyphosphoric acid (H₃PO₄) were allowed to react between 2-25° C. over a period of ca. 3 hr. The reaction temperature increased from 2 to 20° C. within 15 min of the beginning of the addition of the polyphosphoric acid (H₃PO₄), and then more slowly for the remainder of the polyphosphoric acid (H₃PO₄) addition (ca. 2° C. in 15 min). The reactor was allowed to slowly warm to RT over a period of 2-2.5 hr. The reactor pressure did not exceed 15 psia. On completion, the autoclave was disconnected and removed to a fume hood where it was opened, and the contents transferred to a 250 ml FEP sample storage bottle. Approximately 181.96 g of very pale-yellow liquid was recovered representing a yield of ca. 99%. The ¹⁹F NMR spectrum of the recovered liquid showed a resonance consistent with hexafluorophosphoric acid (HPF₆) (doublet, ca. −74 ppm, ¹J_{F-P} 703 Hz) and three weak resonances consistent with H₂PO₃F (doublet, ca. −79 ppm, ¹J_{F-P} 948 Hz), HPO₂F₂ (doublet, ca. −87 ppm, ¹J_{F-P} 976 Hz), and HF (singlet, ca. −172 ppm). The ³¹P NMR spectrum showed a resonance consistent with hexafluorophosphoric acid (HPF₆) (septet, ca. −145 ppm, ¹J_{P-F} 705 Hz).

### Example 1b-Hexafluorophosphoric Acid (HPF₆) Formation in a Single Reactor System

In this example, ca. 187.1 g of AHF was transferred to a pre-weighed PFA bottle fitted with a PFA closure and a PFA plug valve. The AHF was transferred to a stainless-steel autoclave. The autoclave reactor was isolated and cooled to 2-5° C. in an ice water bath. Inside an N₂-purged glove bag, ca. 122.3 g of polyphosphoric acid, polyphosphoric acid (H₃PO₄) (Innophos, H₃PO₄ 115%), was poured into a 250-500 ml three-neck round bottom glass flask through a Teflon funnel. The flask was then sealed and removed to the fume hood where it was placed on a heating mantle which was placed on a scale and then connected to a peristaltic pump via all fluoroplastic fittings and tubing. The peristaltic pump was then connected to the autoclave reactor through all fluoroplastic fittings and tubing. The polyphosphoric acid (H₃PO₄) was then heated to ca. 80° C. under a continuous N₂-flow before being slowly pumped into the autoclave reactor at a rate of 1.5-2 g/min. The AHF and polyphosphoric acid (H₃PO₄) were allowed to react between 2-25° C. over a period of ca. 3 hr. The reaction temperature increased from 2 to 20° C. within 15 min of the beginning of the addition of the polyphosphoric acid (H₃PO₄), and then more slowly for the remainder of the polyphosphoric acid (H₃PO₄) addition (ca. 2° C. in 15 min). The reactor was allowed to slowly warm to RT over a period of 2-2.5 hr. The reactor pressure did not exceed 15 psia. On completion, the autoclave was disconnected and removed to a fume hood where it was opened, and the contents transferred to a 250 ml FEP sample storage bottle. Approximately 298.8 g of aqua colored liquid was recovered representing a yield of ca. 96.6%. The ¹⁹F NMR spectrum of the recovered liquid showed a strong resonance consistent with hexafluorophosphoric acid (HPF₆), and three weak resonances consistent with H₂PO₃F, HPO₂F₂, and HF and the ³¹P NMR spectrum showed a resonance consistent with hexafluorophosphoric acid (HPF₆).

### Example 2a-Co-Production of Phosphorus Pentafluoride (PF₅) and Fluorosulfonic Acid (HSO₃F) in a Single Reactor System

In this example, the co-production of gaseous phosphorus pentafluoride (PF₅) and fluorosulfonic acid (HSO₃F) was demonstrated. In a typical experiment, ca. 82 g of 62-67% aqueous hexafluorophosphoric acid (HPF₆) (HPF₆; ca. 52 g, 0.35 mol) was transferred to a PFA bottle (Savillex, 120 mL Column Component Vessel, Flat Interior, 1½″ MNPT) which was fitted with a PFA closure (Savillex, 58 mm Transfer Closure, ¼″ OD Tube Port, 1½″ FNPT) and a PFA Plug Valve (Swagelok, ¼ in. Swagelok Tube Fitting). The PFA vessel containing the hexafluorophosphoric acid (HPF₆) was then connected via all fluoroplastic and ¼″ stainless steel connections through a peristaltic pump (Masterflex L/S) to a Teflon-lined 600 ml stainless steel autoclave (Parr Instrument Co., Series 4560). The autoclave, which was previously charged with ca. 493 g 30% oleum (SO₃; ca. 148 g, 1.8 mol) inside an N₂-purged glove bag, was then cooled to 2-5° C. in an ice bath and then quickly evacuated to an internal pressure of ca. 1 psia before the hexafluorophosphoric acid (HPF₆) was introduced at a rate of 3-5 g/min with continuous stirring over a period of ca. 17 min. During the reaction the temperature increased to ca. 42° C. with a corresponding pressure increase to ca. 7 psia. After ca. 60% of the feed was added, the autoclave was opened to the product collection cylinder (PCC) under static vacuum to collect the newly generated phosphorus pentafluoride (PF₅) gas. On completion of the hexafluorophosphoric acid (HPF₆) transfer the ice bath was removed, the PCC was opened to dynamic vacuum, and the autoclave was then slowly heated to ca. 117° C. and held for 5-10 min before the heat was turned off and the autoclave allowed to cool to RT. The autoclave was then isolated from the dynamic vacuum and backfilled to ca. 1 atm with dry N₂ gas. The experiment yielded ca. 71 g of material recovered from the PCC and ca. 504 g of material recovered from the autoclave and a resulting material balance of ca. 99.7%.

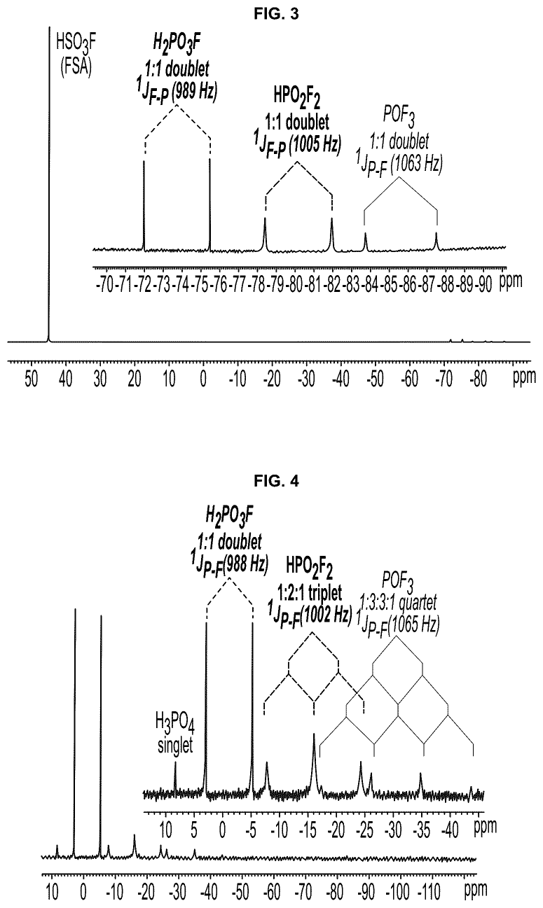

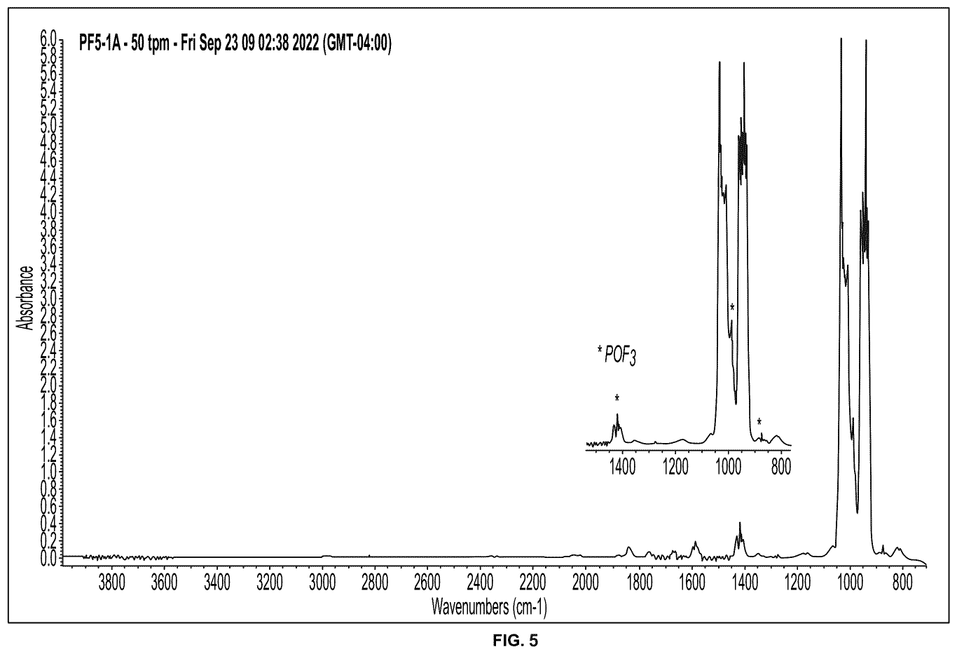

The recovered liquid from the autoclave was analyzed by ¹⁹F and ³¹P NMR spectroscopy which is presented in FIGS. 2-3. The ¹⁹F NMR spectrum of the recovered liquid showed four resonances which were consistent with H₂PO₃F (doublet, ca. −74 ppm, ¹J_{F-P} 989 Hz), HPO₂F₂ (doublet, ca. −80 ppm, ¹J_{F-P} 1005 Hz), POF₃ (doublet, ca. −86 ppm, ¹J_{F-P} 1063 Hz), and fluorosulfonic acid (HSO₃F) (singlet, ca. 45 ppm). Based on the relative intensities of the signals the sample appears to be comprised primarily of fluorosulfonic acid (HSO₃F). The 31P NMR spectrum shows resonances consistent with H₂PO₃F (doublet, ca. −1 ppm, ¹J_{P-F} 989 Hz), HPO₂F₂ (triplet, ca. −16 ppm, ¹J_{P-F} 1002 Hz), and POF₃ (quartet, ca. −30 ppm, ¹J_{P-F} 1065 Hz). A much weaker resonance is observed at ca. 8.5 ppm which is a region consistent with H₃PO₄ (singlet, ca. 8.5 ppm).

The FTIR analysis of the gaseous recovered product was consistent with a ca. 76/24% mixture of phosphorus pentafluoride (PF₅) and phosphoryl fluoride (POF₃) as determined by standard addition of pure phosphoryl fluoride (POF₃) (FIG. 4). Vibrational modes associated with phosphorus pentafluoride (PF₅) are observed at ca. 935-957 cm⁻¹ and ca. 1015-1030 cm⁻¹, while vibration modes associated with phosphoryl fluoride (POF₃) are observed at ca. 872, 988, and 1416 cm⁻¹. These assignments are consistent with those reported in the literature.

### Example 2b-Co-Production of Phosphorus Pentafluoride (PF₅) and Fluorosulfonic Acid (HSO₃F) in a Single Reactor System

In this example, the co-production of phosphorus pentafluoride (PF₅) and fluorosulfonic acid (HSO₃F) is demonstrated as described in example 2a, only instead of 30% oleum, 67% oleum was employed. In a typical experiment, ca. 235 g of 62-67% aqueous hexafluorophosphoric acid (HPF₆) (HPF₆; ca. 164 g, 1.13 mol) was transferred to a PFA bottle (Savillex, 120 mL Column Component Vessel, Flat Interior, 1½″ MNPT) which was fitted with a PFA closure (Savillex, 58 mm Transfer Closure, ¼″ OD Tube Port, 1½″ FNPT) and a PFA Plug Valve (Swagelok, ¼ in. Swagelok Tube Fitting). The PFA vessel containing the hexafluorophosphoric acid (HPF₆) was then connected via all fluoroplastic and ¼″ stainless steel connections through a peristaltic pump (Masterflex L/S) to a Teflon-lined 600 ml stainless steel autoclave (Parr Instrument Co., Series 4560). The autoclave, which was previously charged with ca. 512 g 67% oleum (SO₃; ca. 343 g, 4.30 mol) inside an N₂-purged glove bag, was then cooled to ca. 2-5° C. in an ice bath and then quickly evacuated to an internal pressure of ca. 1 psia before the hexafluorophosphoric acid (HPF₆) was introduced at a rate of ca. 3-5 g/min with continuous stirring over a period of ca. 75 min. During the reaction the temperature increased to ca. 45° C. with a corresponding pressure increase to ca. 7 psia. After ca. 60% of the feed was added, the autoclave was opened to the product collection cylinder (PCC) under static vacuum to collect the newly generated phosphorus pentafluoride (PF₅) gas. On completion of the hexafluorophosphoric acid (HPF₆) transfer the ice bath was removed, the PCC was opened to dynamic vacuum, and the autoclave was then slowly heated to ca. 110° C. and held for ca. 5-10 min before the heat was turned off and the autoclave allowed to cool to RT. The autoclave was then isolated from the dynamic vacuum and backfilled to ca. 1 atm with dry N₂ gas. The experiment yielded ca. 67 g of material recovered from the PCC and ca. 675 g of material recovered from the autoclave and a resulting material balance of ca. 99.3%.

### Example 2c-Co-Production of Phosphorus Pentafluoride (PF₅) and Fluorosulfonic Acid (HSO₃F) in a Single Reactor System

In this example, the co-production of phosphorus pentafluoride (PF₅) and fluorosulfonic acid (HSO₃F) is demonstrated as described in example 2b, only instead of the addition of 62-67% hexafluorophosphoric acid (HPF₆) to 67% oleum, the order of addition was reversed. In a typical experiment, ca. 513 g of 67% oleum (SO₃; ca. 344 g, 4.3 mol) was transferred to a 1 L 3-neck glass round-bottom flask which was fitted with two glass adapters (Ace Glass, #5028-30 adapter, #7 Ace-Thred top, 24/40 inner bottom, nylon bushing with FETFE O-ring) with corresponding PTFE bushings (Ace Glass, #5029-35 #7 PTFE bushing, 7.5 mm center hole, (2) FETFE O-ring) and equipped with PFA Plug Valves (Swagelok, ¼ in. Swagelok Tube Fitting). The center neck of the vessel was isolated using a standard glass vacuum stopcock. The flask was then connected via all fluoroplastic and ¼″ stainless steel connections through a peristaltic pump (Masterflex L/S) to a Teflon-lined 600 ml stainless steel autoclave (Parr Instrument Co., Series 4560). The autoclave, which was previously charged with ca. 236 g 62-67% hexafluorophosphoric acid (HPF₆) (HPF₆; ca. 163 g, 1.11 mol) inside an N₂-purged glove bag, was then cooled to ca. 2-5° C. in an ice bath and then quickly evacuated to an internal pressure of ca. 1 psia before the oleum was introduced at a rate of ca. 3-5 g/min with continuous stirring over a period of ca. 110 min. During the reaction the temperature increased to ca. 33° C. with a corresponding pressure increase to ca. 14 psia. After ca. 50% of the feed was added, the autoclave was opened to the product collection cylinder (PCC) under static vacuum to collect the newly generated phosphorus pentafluoride (PF₅) gas. On completion of the hexafluorophosphoric acid (HPF₆) transfer the ice bath was removed, the PCC was opened to dynamic vacuum, and the autoclave was then slowly heated to ca. 83° C. and held for ca. 5-10 min before the heat was turned off and the autoclave allowed to cool to RT. The autoclave was then isolated from the dynamic vacuum and backfilled to ca. 1 atm with dry N₂ gas. The experiment yielded ca. 125 g of material recovered from the PCC and ca. 621 g of material recovered from the autoclave and a resulting material balance of ca. 99.7%.

### Example 3-Co-Production of Phosphorus Pentafluoride (PF₅) and Fluorosulfonic Acid (HSO₃F) in a Single Reactor System

In this example, the co-production of phosphorus pentafluoride (PF₅) and fluorosulfonic acid (HSO₃F) was demonstrated as described in Example 2c, only without immediately heating the autoclave solution at the end of the reaction. Reactions performed following the same procedure as example 2c with changing the oleum to hex acid mass ratio. The reaction temperature typically increased to 30-50° C. during the reaction due to the reaction exotherm. After complete addition of oleum to the hex-acid solution, the ice bath was removed. Once the autoclave temperature was at room temperature, the autoclave content was transferred to a PFA bottle and analyzed using ¹⁹F NMR spectroscopy.

The gas products collected in the PCCs were analyzed using FTIR spectroscopy to determine the phosphoryl fluoride (POF₃) content. In summary, FTIR spectra were recorded for pure phosphoryl fluoride (POF₃) and the PCCs at the same day (or within the same week). The relative intensity of the phosphoryl fluoride (POF₃) signal at 1416 cm⁻¹ was used to calculate the phosphoryl fluoride (POF₃) content, using Equation 1.

unknown cylinder POF₃ signal intensity/Pure POF3 signal intensity=X_{POF}_{₃}P/P=X_{POF}_{₃} (Equation 1)

Where X_{POF}_{₃} is the mole fraction of phosphoryl fluoride (POF₃) and P is the total pressure of the FTIR cell. The phosphorus pentafluoride (PF₅) mole fraction was determined using X_{PF}_{₅}=1−X_{POF}_{₃}. All the measurements were performed with 20 torr of the sample in the FTIR cell. Note that validity of this method depends on a linear signal with respect to partial pressure of phosphoryl fluoride (POF₃), which we validated it using standard addition method.

The liquid samples were analyzed using ¹⁹F NMR spectroscopy and using an internal standard. In summary, 5 microliter of difluoroacetic acid internal standard was added to a known amount of the liquid sample (1-2 grams). The observed species in the ¹⁹F NMR spectra were quantified using their signal intensities relative to the internal standard after considering the difference in the number of fluorine atoms.

The product quantification results for the phosphorus pentafluoride (PF₅) and phosphoryl fluoride (POF₃) collected in the PCCs as well as FSA and HₓPO_{y}F_{z} in the autoclave are presented in Table 1. The yields were calculated using % Yield=(Moles of the product/Initial moles of HPF₆ in autocalve)×100. FSA wt. % represents the weight percentage of FSA in the liquid phase of autoclave contents.

TABLE 1
Product distribution as a function of oleum/hex-acid ratio

| | n_{SO3}/ | | | | | | |
|---|---|---|---|---|---|---|---|
| | (n_{H2O} + | | PF₅ | POF₃ | HxPOyFz | FSA | Overall |
| Exp | n_{HF} + | n_{SO3}/ | Yield, | Yield, | Yield, | wt. | mass |
| # | n_{HPF6}) | n_{H2O} | % | % | % | % | balance |
| 3-1 | 0.87 | 1.31 | 33 | 7 | 50 | 39 | 99% |
| 3-2 | 0.97 | 1.34 | 58 | 4 | 36 | 28 | 98% |
| 3-3 | 1.03 | 1.43 | 46 | 7 | 31 | 32 | 96% |
| 3-4 | 0.71 | 1.01 | 39 | 15 | 34 | 38 | 98% |
| 3-5 | 1.04 | 1.49 | 38 | 13 | 36 | 28 | 99% |
| 3-6 | 0.95 | 1.43 | 49 | 11 | 33 | 36 | 97% |

For two selected runs (3-2 and 3-4), the autoclave content was transferred back to the autoclave and evacuated at room temperature to an internal pressure of ca. 1 psia. Then, the autoclave was heated to 100-120° C. for 1 hour using the same set up as example 2c, only without oleum addition line. During heating, the autoclave was opened to the product collection cylinder (PCC) under static vacuum to collect the newly generated phosphorus pentafluoride (PF₅) and phosphoryl fluoride (POF₃) gases. After one hour, the autoclave content was allowed to cool down to room temperature. The autoclave and the PCCs were opened to dynamic vacuum at room temperature for five minutes and then isolated. The quantification results for the collected products in the PCCs and the spent liquid in the autoclave are presented in Table 2. The presented phosphorus pentafluoride (PF₅) and phosphoryl fluoride (POF₃) yields in Table 2 are the combined yields of the gas phase products (before heating+after heating) collected in the PCCs; the HxPOyFz yield represents what is left in the autoclave after heating. In general, the HxPOyFz species left in the autoclave are converted to phosphorus pentafluoride (PF₅) and phosphoryl fluoride (POF₃) upon heating in the expense of FSA content.

TABLE 2
Product distribution for two runs

| | PF₅ | POF₃ | HxPOyFz | HSO₃F |
|---|---|---|---|---|
| Exp # | Yield | Yield | Yield | wt. % |
| 3-2 | 65% | 16% | 1.4% | 13% |
| 3-4 | 56% | 26% | 0.8% | 11% |

### Example 4-Co-Production of Phosphorus Pentafluoride (PF₅) and Fluorosulfonic Acid (HSO₃F) in an Integrated Piloting Unit

This example demonstrates the co-production of phosphorus pentafluoride (PF₅) and fluorosulfonic acid (HSO₃F) in an integrated piloting unit.

In the first step, the hexafluorophosphoric acid (HPF₆) is produced in a 100-gallon Hastelloy C276 agitated reactor. After the reactor is evacuated 520 lbs of AHF is charged to it. 340 lbs of commercial grade polyphosphoric acid, polyphosphoric acid (H₃PO₄ 115%) is added using a pump to the reactor from a heated SS holding tank kept at ca. 50° C. over 5-10 hours while keeping agitator on. Upon the completion of addition, elevated temperature up to 50° C. is observed. The reactor is continuously stirred until it cools to below 30° C. A sample is taken and analyzed by Karl-Fischer titration. The concentration of hexafluorophosphoric acid (HPF₆) is determined to be 62-67 wt. %. The reactor contents (ca. 834 lbs) are then transferred to polyethylene lined 55-gallon drums.

In the second step, phosphorus pentafluoride (PF₅) and fluorosulfonic acid (HSO₃F) are produced in a 250 gallon Hastelloy C276 agitated reactor with a jacket which allows to cool the reactor temperature to about 2-5° C. before reaction. After the reactor is evacuated 834 lbs of hexafluorophosphoric acid (HPF₆) aqueous solution is charged to it. The maximum cooling is applied to cool the reactor temperature to 2-5° C. 2223 lbs of 67% oleum is added using a pump to the reactor from a 316 SS holding tank over 5-10 hours while keeping agitator on. During the reaction the reactor temperature is controlled to be below 20° C. before 60% of oleum is added. The cooling and the oleum rate can then be adjusted to maintain phosphorus pentafluoride (PF₅) pressure to be 3-10 psig. The gaseous products (PF₅, POF₃, etc.) are separated in a 316 SS distillation column 1 (12 stages, P(OH)=1 atm, reflux ratio=2.0) sitting on the top of step 2 reactor. Ca. 353 lbs of phosphorus pentafluoride (PF₅) (>99.7%) is collected in a collection tank from the overhead stream, and ca. 96 lbs of POF₃/PF₅ (78% POF₃ and 22% PF₅) is collected in a collection tank from the side stream (stage number=8). When step 2 reactor pressure starts to drop, the reactor is heated up to 110° C. to drive off the remaining gaseous products.

After the reactor temperature cools to below 50° C., the reactor liquid contents are sent to a 316 SS distillation column 2 (Number of stage=8, reflux ratio=1.5, P(OH)=1 atm) to separate fluorosulfonic acid (HSO₃F). Ca. 585 lbs of fluorosulfonic acid (HSO₃F) (>99.9% pure) is collected from the overhead of distillation column 2.

### Example 5-Co-Production of Phosphorus Pentafluoride (PF₅) and Fluorosulfonic Acid (HSO₃F) in an Integrated Piloting Unit

This example demonstrates the co-production of phosphorus pentafluoride (PF₅) and fluorosulfonic acid (HSO₃F) in an integrated piloting unit with phosphoryl fluoride (POF₃) recycled to the first step.

In the first step, the hexafluorophosphoric acid (HPF₆) is produced in a 100-gallon Hastelloy C276 agitated reactor (reactor-1). After the reactor is evacuated 567 lbs of AHF is charged to it. 340 lbs of commercial grade polyphosphoric acid (H₃PO₄ 115%) is added using a pump to the reactor from a heated SS holding tank kept at ca. 50° C. over 5-10 hours while keeping agitator on. 96 lbs of 78% phosphoryl fluoride (POF₃) and 22% phosphorus pentafluoride (PF₅) collected in Example 4 is then added to Reactor 1 from Collection Tank 1 through a sparge over 3-5 hours while keeping agitator on. Upon the completion of addition, elevated temperature up to 50° C. is observed. The reactor is continuously stirred until it cools to below 30° C. A sample is taken and analyzed by Karl-Fischer titration. The concentration of hexafluorophosphoric acid (HPF₆) is determined to be 62-71 wt. %. The reactor contents (ca. 977 lbs) are then transferred to polyethylene lined 55-gallon drums.

In the second step, phosphorus pentafluoride (PF₅) and fluorosulfonic acid (HSO₃F) are produced in a 250-gallon Hastelloy C276 agitated reactor with a jacket which allows to cool the reactor temperature to about 2-5° C. before reaction. After the reactor is evacuated 977 lbs of hexafluorophosphoric acid (HPF₆) aqueous solution is charged to it. The maximum cooling is applied to cool the reactor temperature to 2-5° C. 2413 lbs of 67% oleum is added using a pump to the reactor from a 316 SS holding tank over 5-10 hours while keeping agitator on. During the reaction the reactor temperature is controlled to be below 20° C. before 60% of oleum is added. The cooling and the oleum rate can then be adjusted to maintain phosphorus pentafluoride (PF₅) pressure to be 3-10 psig. The gaseous products (PF₅, POF₃, etc.) are separated in a 316 SS distillation column 1 (12 stages, P (overhead)=1 atm, reflux ratio=2.0) sitting on the top of reactor-2. Ca. 434 lbs of PF₅ (>99.7%) is collected in a collection tank from the overhead stream, and ca. 118 lbs of POF₃/PF₅ (78% POF₃ and 22% PF₅) is collected in a collection tank from the side stream (stage number=8). When step 2 reactor pressure starts to drop, the reactor is heated up to 110° C. to drive off the remaining gaseous products.

After the reactor temperature cools to below 50° C., the reactor liquid contents are sent to a 316 SS distillation column 2 (Number of stages=8, reflux ratio=1.5, P (overhead)=1 atm) to separate fluorosulfonic acid (HSO₃F). Ca. 675 lbs of fluorosulfonic acid (HSO₃F) (>99.9% pure) is collected from the overhead of distillation column 2.

### Example 6-Co-Production of Phosphorus Pentafluoride (PF₅), Difluorophosphoric Acid (HPO₂F₂), and Fluorosulfonic Acid (HSO₃F) in an Integrated Piloting Unit

This example demonstrates the co-production of phosphorus pentafluoride (PF₅), difluorophosphoric acid (HPO₂F₂), and fluorosulfonic acid (HSO₃F) in an integrated piloting unit, similar to the Example 4 but without heating the reactor at the end of oleum addition.

In the first step, the hexafluorophosphoric acid (HPF₆) is produced in a 100-gallon Hastelloy C276 agitated reactor. After the reactor is evacuated 520 lbs of AHF is charged to it. 340 lbs of commercial grade polyphosphoric acid (H₃PO₄ 115%) is added using a pump to the reactor from a heated SS holding tank kept at ca. 50° C. over 5-10 hours while keeping agitator on. Upon the completion of addition, elevated temperature up to 50° C. is observed. The reactor is continuously stirred until it cools to below 30° C. A sample is taken and analyzed by Karl-Fischer titration. The concentration of hexafluorophosphoric acid (HPF₆) is determined to be 62-67 wt. %. The reactor contents (ca. 834 lbs) are then transferred to polyethylene lined 55-gallon drums.

In the second step, phosphorus pentafluoride (PF₅), difluorophosphoric acid (HPO₂F₂), and fluorosulfonic acid (HSO₃F) are produced in a 250 gallon Hastelloy C276 agitated reactor with a jacket which allows to cool the reactor temperature to about 2-5° C. before reaction. After the reactor is evacuated 834 lbs of hexafluorophosphoric acid (HPF₆) aqueous solution is charged to it. The maximum cooling is applied to cool the reactor temperature to 2-5° C. 2223 lbs of 67% oleum is added using a pump to the reactor from a 316 SS holding tank over 5-10 hours while keeping agitator on. During the reaction the reactor temperature is controlled to be below 20° C. before 60% of oleum is added. The cooling and the oleum rate can then be adjusted to maintain phosphorus pentafluoride (PF₅) pressure to be 3-10 psig. The gaseous products (PF₅, POF₃, etc.) are separated in a 316 SS distillation column 1 (12 stages, P (overhead)=1 atm, reflux ratio=2.0) sitting on the top of step 2 reactor. Ca. 275 lbs of PF₅ (>99.7%) is collected in a collection tank from the overhead stream, and ca. 20 lbs of POF₃/PF₅ (78% POF₃ and 22% PF₅) is collected in a collection tank from the side stream (stage number=8).

After complete addition of oleum, the cooling jacket is turned off. When the temperature is about room temperature, the reactor liquid contents are sent to a 316 SS distillation column 2 to separate difluorophosphoric acid (HPO₂F₂). The overhead pressure of column-2 is 5 torr. The number of stages in column-2 is 10 and the reflux ratio is 3.0. The column bottom is preloaded with sulfuric acid (H₂SO₄) and the reboiler temperature is 82° C. 77.8 lb overhead stream is collected. The purity of difluorophosphoric acid (HPO₂F₂) in the overhead stream is 99.2% and the recovery ratio is 99%. The bottom stream of column-2 is sent to column-3 to separate fluorosulfonic acid (HSO₃F) and sulfuric acid (H₂SO₄). Column-3 overhead pressure is 1 atm and the stage number is 8. The reflux ratio of column-3 is 1.5. 819 lb (99.9% pure) fluorosulfonic acid (HSO₃F) is recovered in the overhead stream of column-3.

### ASPECTS

Aspect 1 is an integrated process for co-producing phosphorus pentafluoride (PF₅) and fluorosulfonic acid (HSO₃F) comprising:
(1) reacting anhydrous hydrofluoric acid (AHF) with polyphosphoric acid (H₃PO₄) in a first reactor to produce a first product mixture comprising hexafluorophosphoric acid (HPF₆); and
(2) reacting the first product mixture with oleum (H₂SO₄·SO₃) in a second reactor to produce a second product mixture comprising phosphorus pentafluoride (PF₅) and fluorosulfonic acid (HSO₃F).

Aspect 2 is the process of Aspect 1, further comprising, after the reaction step (2), the additional step of conveying the second product mixture to a distillation column to recover purified fluorosulfonic acid (HSO₃F).

Aspect 3 is the process of Aspect 2, wherein the recovered fluorosulfonic acid (HSO₃F) is greater than about 99% pure as determined by NMR spectroscopy.

Aspect 4 is the process of Aspect 1, further comprising, after the reaction step (2), the additional step of conveying the second product mixture is to a distillation column to recover purified difluorophosphoric acid (HPO₂F₂).

Aspect 5 is the process of Aspect 1, wherein the first reacting step (1) utilizes a stoichiometric excess of anhydrous hydrofluoric acid (AHF) relative to the amount of polyphosphoric acid (H₃PO₄).

Aspect 6 is the process of Aspect 1, wherein the polyphosphoric acid (H₃PO₄) is at a temperature of about 40° C. to about 60° C. before reacting with anhydrous hydrofluoric acid (HF) in the first reacting step (1).

Aspect 7 is the process of Aspect 1, wherein the first reacting step (1) is conducted at a temperature of 20° C. to 50° C.

Aspect 8 is the process of Aspect 1, wherein the second product mixture comprises phosphorus pentafluoride (PF₅) and fluorosulfonic acid (HSO₃F) in a ratio of from about 60 wt. %:40 wt. % to about 80 wt. %:20 wt. %, based on a total weight of the phosphorus pentafluoride (PF₅) and fluorosulfonic acid (HSO₃F) in the second product mixture.

Aspect 9 is the process of Aspect 1, wherein the phosphorus pentafluoride (PF₅) in the second product mixture is recovered in the gas phase.

Aspect 10 is the process of Aspect 9, wherein the recovered phosphorus pentafluoride (PF₅) is greater than about 99% pure as determined by FTIR spectroscopy.

Aspect 11 is the process of Aspect 1, wherein the fluorosulfonic acid (HSO₃F) in the second product mixture is in the liquid phase.

Aspect 12 is the process of Aspect 1, wherein the product mixture further comprises H₂PO₃F, difluorophosphoric acid (HPO₂F₂), phosphoryl fluoride (POF₃), sulfuric acid (H₂SO₄), fluorosulfonic acid (HSO₃F), and combinations of the foregoing.

Aspect 13 is the process of Aspect 1, wherein the second product mixture is substantially free of hydrofluoric acid (HF).

Aspect 14 is the process of Aspect 1, wherein the second product mixture is substantially free of phosphoryl fluoride (POF₃).

Aspect 15 is the process of Aspect 1, wherein the integrated process utilizes a stoichiometric excess of oleum (H₂SO₄·SO₃) in reaction step (2) relative to the amount of hexafluorophosphoric acid (HPF₆).

Aspect 16 is the process of Aspect 1, wherein method does not comprise an hydrofluoric acid (HF) recycle.

Aspect 17 is a process for co-producing phosphorus pentafluoride (PF₅) and fluorosulfonic acid (HSO₃F) comprising:
(1) reacting hexafluorophosphoric acid (HPF₆) with oleum (H₂SO₄·SO₃) in a reactor;
(2) collecting an overhead stream comprising phosphorus pentafluoride (PF₅) from the reactor; and
(3) collecting a bottoms stream comprising fluorosulfonic acid (HSO₃F) from the reactor.

Aspect 18 is the process of Aspect 17, further comprising, after step (2), the additional step of conveying the overhead stream to a distillation column to recover purified phosphorus pentafluoride (PF₅).

Aspect 19 is the process of Aspect 17, further comprising, after step (3), the additional step of conveying the bottoms stream to a distillation column to recover purified fluorosulfonic acid (HSO₃F).

Aspect 20 is the process of Aspect 17, wherein the recovered phosphorus pentafluoride (PF₅) and fluorosulfonic acid (HSO₃F) are each greater than about 99% pure as determined by FTIR spectroscopy and NMR spectroscopy, respectively.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances that fall within the scope of the appended claims.

1. An integrated process for co-producing phosphorus pentafluoride (PF₅) and fluorosulfonic acid (HSO₃F) comprising:
(1) reacting anhydrous hydrofluoric acid (AHF) with polyphosphoric acid (H₃PO₄) in a first reactor to produce a first product mixture comprising hexafluorophosphoric acid (HPF₆); and
(2) reacting the first product mixture with oleum (H₂SO₄·SO₃) in a second reactor to produce a second product mixture comprising phosphorus pentafluoride (PF₅) and fluorosulfonic acid (HSO₃F).

2. The process of claim 1, further comprising, after the reaction step (2), the additional step of conveying the second product mixture to a distillation column to recover purified fluorosulfonic acid (HSO₃F).

3. The process of claim 2, wherein the recovered fluorosulfonic acid (HSO₃F) is greater than about 99% pure as determined by NMR spectroscopy.

4. The process of claim 1, further comprising, after the reaction step (2), the additional step of conveying the second product mixture is to a distillation column to recover purified difluorophosphoric acid (HPO₂F₂).

5. The process of claim 1, wherein the first reacting step (1) utilizes a stoichiometric excess of anhydrous hydrofluoric acid (AHF) relative to the amount of polyphosphoric acid (H₃PO₄).

6. The process of claim 1, wherein the polyphosphoric acid (H₃PO₄) is at a temperature of about 40° C. to about 60° C. before reacting with anhydrous hydrofluoric acid (HF) in the first reacting step (1).

7. The process of claim 1, wherein the first reacting step (1) is conducted at a temperature of 20° C. to 50° C.

8. The process of claim 1, wherein the second product mixture comprises phosphorus pentafluoride (PF₅) and fluorosulfonic acid (HSO₃F) in a ratio of from about 60 wt. %:40 wt. % to about 80 wt. %:20 wt. %, based on a total weight of the phosphorus pentafluoride (PF₅) and fluorosulfonic acid (HSO₃F) in the second product mixture.

9. The process of claim 1, wherein the phosphorus pentafluoride (PF₅) in the second product mixture is recovered in the gas phase.

10. The process of claim 9, wherein the recovered phosphorus pentafluoride (PF₅) is greater than about 99% pure as determined by FTIR spectroscopy.

11. The process of claim 1, wherein the fluorosulfonic acid (HSO₃F) in the second product mixture is in the liquid phase.

12. The process of claim 1, wherein the product mixture further comprises H₂PO₃F, difluorophosphoric acid (HPO₂F₂), phosphoryl fluoride (POF₃), sulfuric acid (H₂SO₄), fluorosulfonic acid (HSO₃F), and combinations of the foregoing.

13. The process of claim 1, wherein the second product mixture is substantially free of hydrofluoric acid (HF).

14. The process of claim 1, wherein the second product mixture is substantially free of phosphoryl fluoride (POF₃).

15. The process of claim 1, wherein the integrated process utilizes a stoichiometric excess of oleum (H₂SO₄·SO₃) in reaction step (2) relative to the amount of hexafluorophosphoric acid (HPF₆).

16. The process of claim 1, wherein method does not comprise an hydrofluoric acid (HF) recycle.

17. A process for co-producing phosphorus pentafluoride (PF₅) and fluorosulfonic acid (HSO₃F) comprising:
(1) reacting hexafluorophosphoric acid (HPF₆) with oleum (H₂SO₄·SO₃) in a reactor;
(2) collecting an overhead stream comprising phosphorus pentafluoride (PF₅) from the reactor; and
(3) collecting a bottoms stream comprising fluorosulfonic acid (HSO₃F) from the reactor.

18. The process of claim 17, further comprising, after step (2), the additional step of conveying the overhead stream to a distillation column to recover purified phosphorus pentafluoride (PF₅).

19. The process of claim 17, further comprising, after step (3), the additional step of conveying the bottoms stream to a distillation column to recover purified fluorosulfonic acid (HSO₃F).

20. The process of claim 17, wherein the recovered phosphorus pentafluoride (PF₅) and fluorosulfonic acid (HSO₃F) are each greater than about 99% pure as determined by FTIR spectroscopy and NMR spectroscopy, respectively.
